(19) United States
(12) Patent Application Publication
(10) Pub. No.: US 2025/0343357 A1
(43) Pub. Date: Nov. 6, 2025

(54) TRAVELLING WAVE ANTENNA DESIGN

(71) Applicant: Battelle Memorial Institute, Columbus, OH (US)

(72) Inventor: Thomas L. MOFFITT, San Diego, CA (US)

(21) Appl. No.: 19/196,520

(22) Filed: May 1, 2025

Related U.S. Application Data
(60) Provisional application No. 63/640,972, filed on May 1, 2024.

(51) Int. Cl. H01Q 11/02; H01Q 21/06

(52) U.S. Cl. CPC H01Q 11/02; H01Q 21/061

(57) ABSTRACT

The present disclosure provides a travelling wave antenna (TWA) structure. The TWA structure includes a feed layer comprising a plurality of unit cells, each unit cell of the feed layer being formed of an antenna structure. The TWA structure also includes a metal layer disposed over the feed layer, the metal layer comprising a plurality of unit cells aligned with the plurality of unit cells of the feed layer; each unit cell of the metal layer having a pattern of metal segments; wherein a size and geometry of the metal segments controlling, at least in part, an impedance of the metal layer. The TWA structure also includes a spacer layer disposed between the metal layer and the feed layer.

### CROSS REFERENCE TO RELATED APPLICATIONS

The present application claims the benefit of U.S. Provisional Patent Application Ser. No. 63/640,972, filed May 1, 2024, which is hereby incorporated by reference in its entirety.

### TECHNICAL FIELD

The present disclosure is generally directed to antenna designs, and more particularly, to travelling wave antenna design structures.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A illustrates a cross-sectional view of a travelling wave antenna (TWA) structure according to embodiments of the present disclosure;

FIG. 1B illustrates top-down partial views of example metal layers shown in FIG. 1A;

FIG. 1C illustrates a top down view of an example feed layer shown in FIG. 1A; and

FIG. 2 illustrates a flowchart of example TWA design operations according to one embodiment.

Although the following Detailed Description will proceed with reference being made to illustrative embodiments, many alternatives, modifications and variations thereof will be apparent to those skilled in the art.

### DETAILED DESCRIPTION

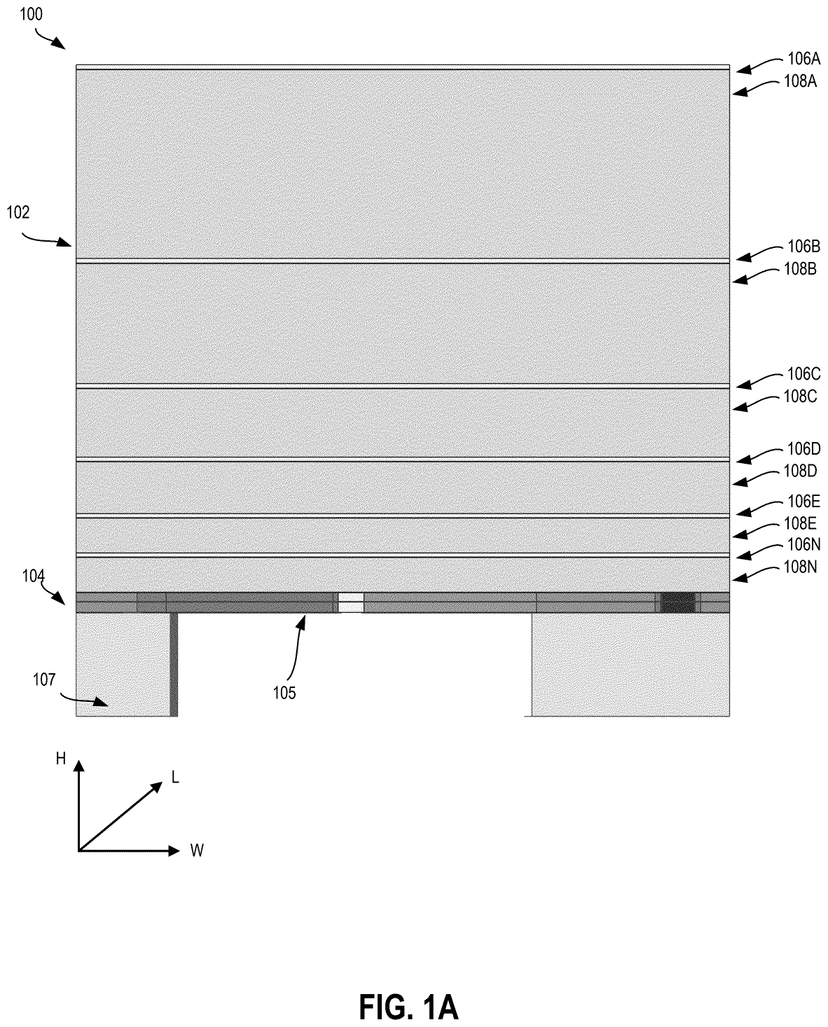

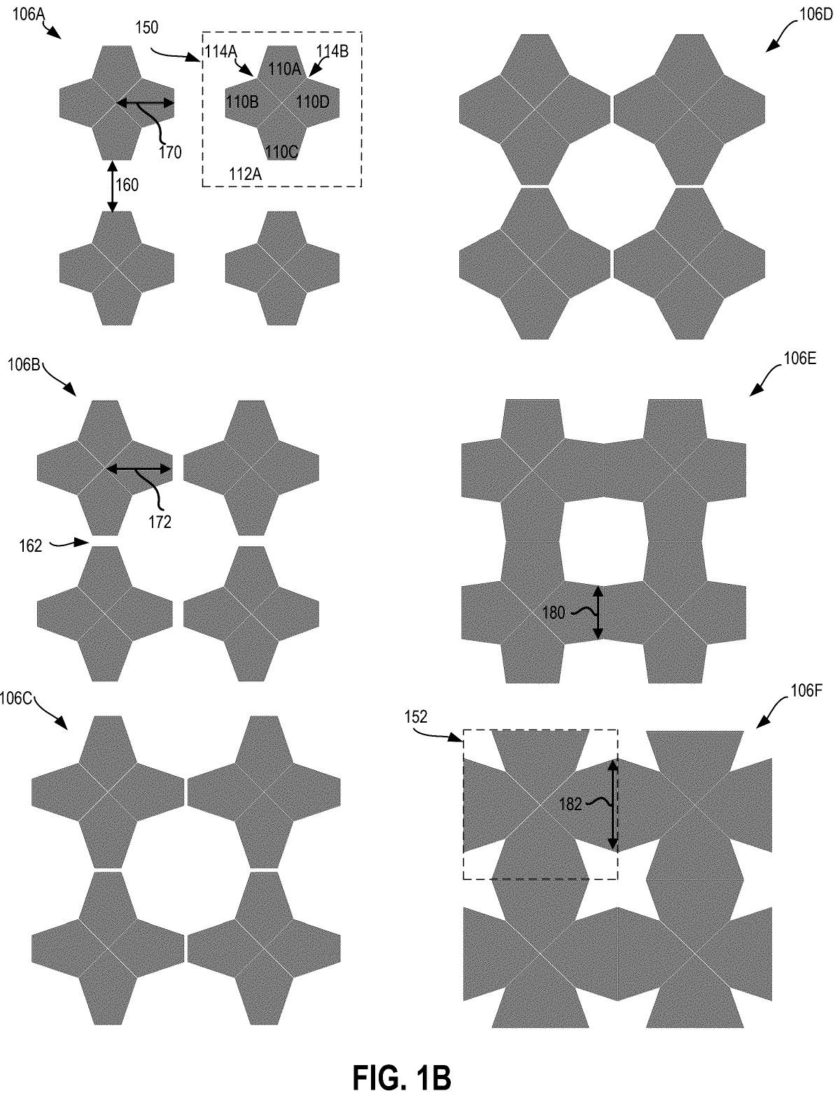

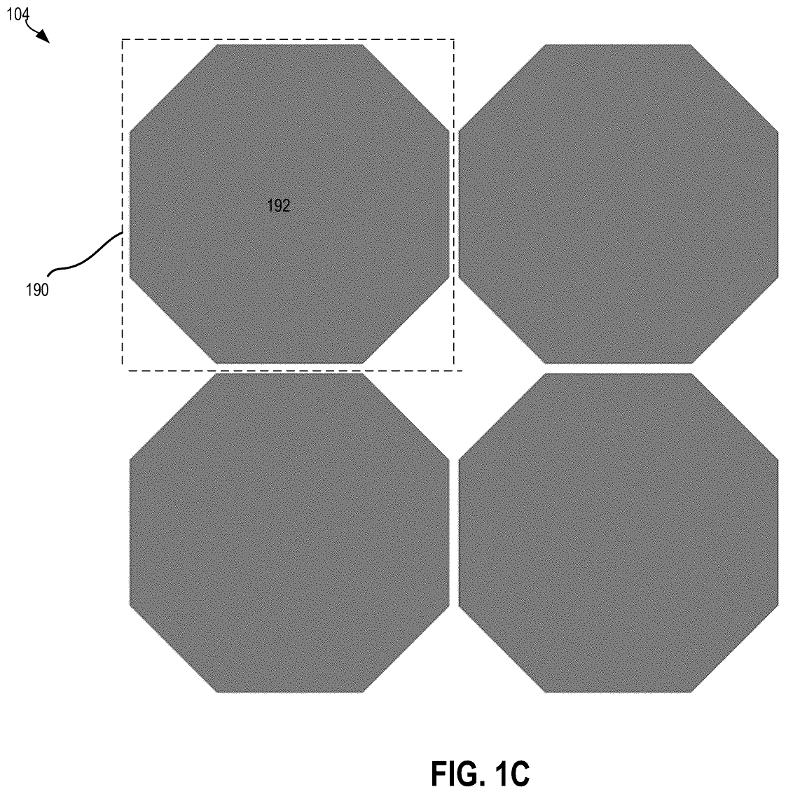

The present disclosure describes travelling wave antenna (TWA) structures and methods of forming TWA structures. FIG. 1A illustrates a cross-sectional view of a TWA 100 according to embodiments of the present disclosure. The TWA 100 may consist of a plurality of “unit cells” which form an array, in which the unit cell is duplicated across the array for a desired power output, gain, number of beamforming channels, etc. The TWA 100 generally includes at least one transmission layer, shown generally at 102, disposed over a feed layer structure 104. The feed layer 104 is generally defined as an antenna structure, for example, an array that includes a tapered antenna, connected dipole antenna, connected slot antenna, etc. The feed layer 104 generally includes a metal layer 110 disposed over a ground structure 112. Each of the plurality of transmission layers 102 behaves similarly to an artificial transmission line. In the case of a single transmission layer 106N disposed over the feed layer 104, the transmission layer 106N operates to transform an impedance from the feed layer 104 to free-space impedance (in a transmission Tx operating mode) and to transform free-space impedance to the impedance of the feed layer 104 (in a receive Rx operating mode). In the case of a plurality of stacked transmission layers 106A, 106B, . . . 106N, each transmission layer operates to successively transform an impedance from the feed layer 104 to free-space impedance (in a transmission Tx operating mode) and to transform free-space impedance to the impedance of the feed layer 104 (in a receive Rx operating mode). The stacked transmission layers 106A, 106B, . . . 106N are generally parallel to one another and to the feed layer 104.

The feed layer 104 is composed of a plurality of “unit cells” where each unit cell is an antenna structure. Each metal layer 106A, 106B, . . . 106N is composed of a plurality of unit cells, and each unit cell of the metal layers 106A, 106B, . . . 106N is (vertically) aligned with each unit cell of the feed layer 104. Unit cells are described in greater detail below.

The plurality of transmission layers 102 generally include a plurality of stacked metal layers 106A, 106B, . . . , 106N each being separated by a spacer layer 108A, 108B, . . . , 108N, as illustrated. In one example embodiment, each metal layer 106A, 106B, . . . , 106N may be formed using a PCB (e.g., 10 mil Rogers RO4350B) material and each spacer layer 108A, 108B, . . . , 108N may be formed of foam (e.g., Rohacell IG-F 51). In other embodiments, the space between each metal layer 106A, 106B, . . . , 106N may be air, or some other dielectric material. The feed layer 104 is composed of a plurality of “unit cells” where each unit cell is an antenna structure. Each metal layer 106A, 106B, . . . 106N is composed of a plurality of unit cells, and each unit cell of the metal layers 106A, 106B, . . . 106N is (vertically) aligned with each unit cell of the feed layer 104. Unit cells are described in greater detail below.

As a general matter, the number of metal layers 106A, 106B, . . . , 106N and the number of spacer layers layer 108A, 108B, . . . , 108N is determined by a desired bandwidth ratio of the TWA 100. A “bandwidth ratio” is generally defined as the highest operating frequency divided by the lowest operating frequency. In some embodiments, the number of metal layers is generally defined as 1.2-1.5*the bandwidth ratio. Using 1.5 times the bandwidth ratio as an example, and assuming for this example that the TWA 100 operates operate at 1 GHz to 4 Ghz., (bandwidth ratio of 4:1), 6 layers generates a bandwidth ratio of 4:1 (1.5*4). To increase the bandwidth ratio and increase impedance matching, additional layers may be added (and, accordingly, removing layers operates to decrease the bandwidth ratio and decrease impedance matching). In some embodiments, scaling the number of layers is approximately linear with bandwidth ratio. Thus, for example, a 10:1 bandwidth ratio could be accomplished using 15 layers (10 ratio/4 ratio*6 layers). Of course, these are only examples of the number of metal layers that may be used, and the TWA 100 of the present disclosure can include any number of layers for a desired bandwidth ratio, including a single layer disposed over the feed layer.

To transform an impedance from the feed layer 104 to free-space impedance (in a transmission Tx operating mode) and to transform free-space impedance to the impedance of the feed layer 104 (in a receive Rx operating mode), the thickness (height) of the spacer layers 108A, 108B, . . . , 108N is selected to provide impedance matching. As a general matter, increasing the spacing between each layer (and between the feed layer 104 and the bottom layer 106N) causes the impedance to decrease and the electrical delay to increase. Decreasing the spacing between each layer (and between the feed layer 104 and the bottom layer 106N) causes the impedance to increase and the electrical delay to decrease.

For example, as shown in FIG. 1A, the spacing between metal layer 106A and 106B is larger than a spacing between metal layer 106B and 106C, etc. Accordingly, the overall height (thickness) of the spacer layer 108A is greater than the spacer layer 108B, and so on. As a general matter, each spacer layer is designed so that each transmission layer has approximately the same electrical length (same electrical delay). The thickness of each spacer layer 108A, 108B, . . . , 108N may be generally selected to be less than or equal to 1/4 of the wavelength of the highest operating frequency. As is understood, lower layers (layers closest to the feed layer 104) have a lower impedance and a higher delay than upper layers. Thus, to compensate for increasing impedance and decreasing delay for the higher layers, the present invention provides increasing thickness of each subsequent spacing layer so that each layer has approximately uniform delay. In other words, lower layers have lower impedance thus lower propagation velocity, and thus a total electrical length relative to free space “looks” electrically longer despite their reduced size. This enables a reduction in overall height of the TWA 100 compared to other antenna systems. In addition, the teachings of the present disclosure provide a TWA structure that scales well at low frequency, and can be formed of thin, lightweight metal layers to reduce overall weight.

The TWA 100 is formed having an overall width (W) and length (L) dependent upon, for example, power requirements, desired gain, etc. The TWA 100 is generally composed of an array of “unit cells”, where the length and width may be selected based on a “unit cell” size in an array of multiple unit cell elements, and or other physical size constraints and performance (e.g., power, gain, grating lobe, beamforming channels, etc.) constraints. In some embodiments, overall width (W) and length (L) may be approximately equal. The height (H) of the transmission layers 102 is generally dependent on the lowest operating Tx and Rx frequency requirements. Typically, the total height (H) is 11-15% of a wavelength at the lowest frequency for a −0.5 dB aperture efficiency (worst case at boresight over bandwidth, which is generally considered as acceptable performance). By way of example, for a 1-4 GHz TWA design, the transmission layers 102 have an overall height (H) of approximately 38 mm., which is approximately 12.7% of a wavelength at 1 GHz and achieves better than −0.5 dB aperture efficiency at boresight.

FIG. 1B illustrates top-down partial views of example metal layers 106A, 106B, . . . , 106F shown in FIG. 1A. In this example, the TWA 100 includes 6 layers (N=6). The top layer 106A is shown in the upper left corner panel of FIG. 1B. Each layer 106A, 106B, . . . , 106F is illustrated as having four unit cells, however, those skilled in the art will recognize that a typical array has a number of unit cells greater than four. The area within the dashed box represents one unit cell 150 of the layer 106A of a TWA array, and the area outside the dashed box represents adjacent unit cells of layer 106A (shown within the upper left panel). For clarity, a dashed box is not shown for layers 106B, 106C, . . . , 106E, and is included in the bottom layer 106F (lower right panel). Each metal layer 106A, 106B, . . . , 106E is generally formed using a PCB and etched to form metal segments 110A, 110B, 110C and 110D for each unit cell, with the remainder of each cell of the layer formed of exposed PCB material 112A. The pattern (geometry) of the metal segments 110A, 110B, 110C and 110D is generally repeated across each layer, however, the size of each pattern of metal segments 110A, 110B, 110C and 110D increases from the top layer 106A to the bottom layer 106F. To prevent the metal layer from developing resonance and/or having too low of an impedance value, the metal segments 110A, 110B, 110C and 110D of each unit cell may be generally separated from one another, as illustrated, by gaps 114A and 114B separating each metal segment 110A, 110B, 110C and 110D. The gaps 114A and 114B provide capacitance between metal segments 110A, 110B, 110C and 110D. It should be noted that the overall surface area of metal segments 110A, 110B, 110C and 110D increases from top to bottom in each layer, thus providing a decrease in impedance from the top layer 106A to the bottom layer 106F.

Comparing, for example, layer 106A and 106B, a gap 160 and 162 between adjacent cells is illustrated. The gap 160 is larger in layer 106B than gap 162 in layer 106B. The gaps between adjacent cells decreases in subsequent layers, with layers 106E and 106F having the smallest gap between adjacent cells (as shown by visual comparison of layers 106E and 106F to the other layers). Comparing, for example, layer 106A and 106B, a length 170 of each metal segment in layer 106A is less than a length 172 of each metal segment in layer 106B. Comparing, for example layer 106E and 106F, a width 180 of the metal between adjacent cells of layer 106E is less than a width 182 of the metal between adjacent cells of layer 106F.

As noted above, increased metal in each layer reduces impedance (and thus decreased metal in each layer increases impedance). In addition, the impedance of each layer is generally controlled by the following criteria: increasing the distance between layers (spacer thickness) causes the impedance to decrease (and decreasing it causes the impedance to increase); decreasing the metal gap (e.g., 160/162) between adjacent cells causes the impedance to decrease (and increasing the gap the impedance to increase); increasing the length of the metal to the next gap (170/172) decreases the impedance (and decreasing the length of the metal to the next gap increases the impedance); and increasing the width of the metal between adjacent cells (180/182) causes the impedance to decrease (and decreasing the width of the metal between adjacent cells causes the impedance to increase).

While FIG. 1B illustrates examples of the metal segments associated with each layer, as understood by those skilled in RF antenna design arts, there are infinite possibilities for the geometry, size and the number of metal segments 110A, 110B, 110C and 110D in each layer. However, the geometry, size, and the number of metal segments in each layer may be determined by, for example, a priori knowledge of one skilled in the art in RF antenna design, for example, using known simulation and optimizer tools. As a general guide, the geometry, size and the number of the metal segments of each layer is based on, for example, the overall size of each layer, the impedance target requirements for each layer, the bandwidth ratio of the antenna structure, the number of layers in the antenna structure, etc. In addition, while each unit cell of the TWA 100 illustrated and described herein has a generally rectangular cross sectional shape, other shapes may be used (for example, triangular, circular, oval, irregular, etc.), without departing from the scope of the present disclosure.

In addition to the foregoing, the geometry, size and the number of metal segments in each layer, and the size, geometry and number of layers in the antenna structure is based on the specifics of the aperture being generated by the TWA. For example, the impedance is generally not stable and tends to increase over frequency, and it can also be influenced by the limitations of the manufacturing process, and the feed circuitry is usually not a stable impedance either, and limitations of the construction can change how design is approached. In general, according to the teachings of the present disclosure, planar layers are provided with unique metal geometry and separated that provide an impedance and group delay that is different from free space impedance. Stacking these unique layers on top of each other, as described herein, acts like an impedance transformer from the feed layer 104 to free space. These unique metal layers perform like artificial transmission lines with a characteristic capacitance and inductance that is controlled by adjusting the metal size, geometry and number.

In addition, the unit cells 150 and 152 depicted in FIG. 1B and unit cell 190 depicted in FIG. IC are each provided only as an example representation of a unit cell. Generalized, a unit cells are defined as any repeating pattern of metal segments. Thus, for example, the unit cells 150, 152 and 190 may be defined by shifting the dashed boxes (up, down, left and/or right) so that adjacent unit cells have the same pattern in each layer.

FIG. 1C illustrates a top-down partial view of an example feed layer 104 shown in FIG. 1A. As illustrated, the feed layer 104 includes a plurality of unit cells (four unit cells shown in FIG. 1C). One of the unit cells is illustrated within the dashed box labelled 190. Each unit cell of the feed layer 104 is generally aligned with each unit cell of the one or more metal layers 106A, 106B, . . . , 106F disposed over the feed layer 104. As stated above, the unit cell is composed of an RF feed structure, such a tapered antenna, connected dipole antenna, connected slot antenna, etc., and as the metal structure 192 for unit cell 190. As a general matter, the impedance of the feed layer 104 is less than the impedance of the one or more metal layers disposed over the feed layer 104, and according to the teaching described above, the metal structure 192 has a larger size (larger total surface area) than the metal segments in the metal layers, thus provided decreased impedance.

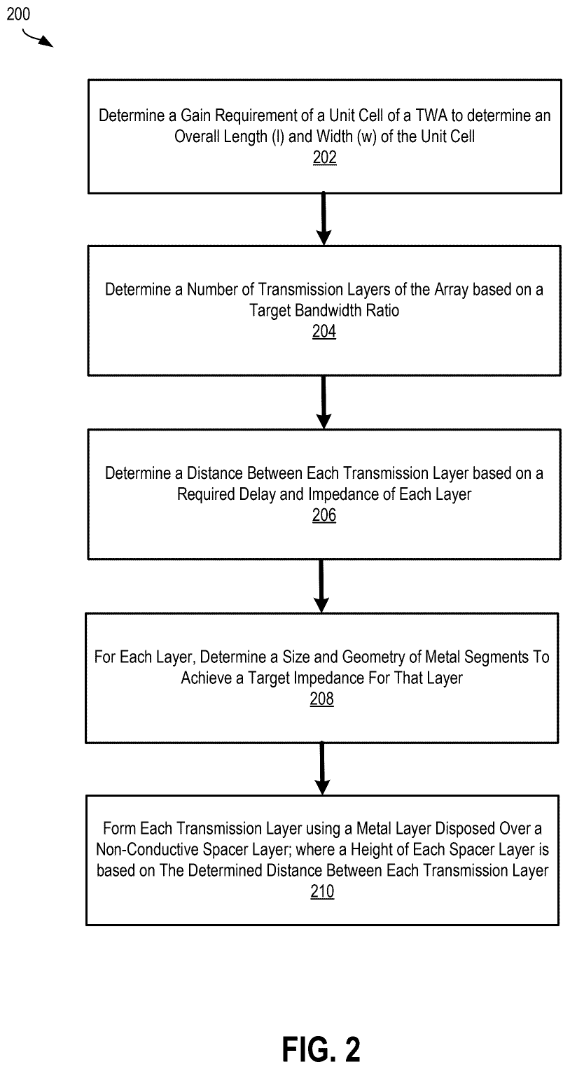

FIG. 2 illustrates a flowchart 200 of operations for designing a TWA structure according to one embodiment of the present disclosure. Operations of this embodiment include determining a gain requirement of a unit cell of a TWA to determine an overall length and width of the TWA structure and of each unit cell 202. Operations further include determining a number of stacked transmission layers of the TWA array based on a target bandwidth ratio 204. Operations also include determining a distance between each transmission layer based on a required delay and impedance of each layer 206. These operations may also generally include determining a distance between each transmission layer based on the impedance of a feed antenna and an output impedance (e.g., free space impedance). Operations further include, for each layer, determine a size and geometry for metal segments for each unit cell to achieve a target impedance for that layer 208. Operations further include forming each transmission layer using a metal layer disposed over a non-conductive spacer layer; where a height of each spacer layer is based the determined distance between each transmission layer 210.

Accordingly, in a first embodiment, the present disclosure provides travelling wave antenna (TWA) structure. The TWA structure includes a feed layer comprising a plurality of unit cells, each unit cell of the feed layer being formed of an antenna structure. The TWA structure also includes a metal layer disposed over the feed layer, the metal layer comprising a plurality of unit cells aligned with the first plurality of unit cells of the feed layer; each unit cell of the metal layer having a pattern of metal segments; wherein a size and geometry of the metal segments controlling, at least in part, an impedance of the unit cell and the metal layer. The TWA structure also includes a spacer layer disposed between the metal layer and the feed layer.

In a second embodiment, the present disclosure provides a travelling wave antenna (TWA) structure that includes a feed layer comprising a plurality of unit cells, each unit cell being formed of an antenna structure; a plurality of stacked metal layers disposed over the feed layer, each of the plurality of stacked metal layers comprising unit cells aligned with the unit cells of the feed layer and aligned with unit cells of adjacent metal layers; each unit cell of each metal layer having a pattern of metal segments; wherein a size and geometry of the metal segments of each unit cell of each metal layer controlling, at least in part, an impedance of the unit cell and the metal layer; and a plurality of spacer layers disposed between a bottom metal layer and the feed layer and disposed between each metal layer.

a feed layer comprising a plurality of comprising a plurality of unit cells, each unit cell being formed of an antenna structure; a plurality of stacked metal layers disposed over the feed layer, each of the plurality of stacked metal layers comprising unit cells aligned with the unit cells of the feed layer and aligned with unit cells of adjacent metal layers; each unit cell of each metal layer having a pattern of metal segments; wherein a size and geometry of the metal segments of each unit cell of each metal layer controlling, at least in part, an impedance of the unit cell and the metal layer; and a plurality of spacer layers disposed between a bottom metal layer and the feed layer and disposed between each metal layer.

In other embodiments described herein, the size and geometry of the metal segments of each unit cell controls an impedance associated with the metal layer; wherein increasing the size of the metal segments of each unit cell causes a decrease in impedance; and wherein a decreasing size of the metal segments of each unit cell causes an increase in impedance.

In other embodiments described herein, a gap between metal segments of adjacent unit cells controls an impedance associated with the metal layer; wherein increasing the gap between metal segments of adjacent unit cells causes an increase in impedance; and wherein a decreasing the gap between metal segments of adjacent unit cells causes a decrease in impedance.

In other embodiments described herein, a length of the gap is selected to be approximately one half or less of a wavelength of a maximum frequency of the bandwidth ratio of the TWA.

In other embodiments described herein, a thickness of the spacer layer controls an impedance value of the metal layer; wherein increasing the thickness of the spacer layer causes a decrease in impedance of the metal layer; and wherein decreasing the thickness of the spacer layer causes an increase in impedance of the metal layer.

In other embodiments described herein, a width of metal segments of adjacent unit cells controls an impedance associated with the metal layer; wherein increasing the width of metal segments of adjacent unit cells causes a decrease in impedance; and wherein a decreasing the width of metal segments of adjacent unit cells causes an increase in impedance.

In other embodiments described herein each spacer layer is selected from foam or plastic.

In other embodiments described herein, the antenna structures of the feed layer include at least one of a tapered antenna, a connected dipole antenna, and a connected slot antenna.

In other embodiments described herein, the plurality of transmission layers includes a top layer and the bottom layer; wherein a spacing between the bottom layer and the feed layer is less than a spacing between the bottom layer and the top layer and wherein the plurality of spacer layers includes a first spacer layer disposed between the feed layer and the bottom layer, and a second spacer layer disposed between the bottom layer and the top layer; wherein the second spacer layer having a greater thickness than the first spacer layer.

In other embodiments described herein, the plurality of metal layers are non-linearly spaced apart from one another to provide an approximate impedance match between the feed layer and free space.

As used herein, the terms “side”, “front”, “back”, “tope”, bottom”, etc. are provided as a descriptive aid, not as a limitation or specific orientation. While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A travelling wave antenna (TWA) structure, comprising:
a feed layer comprising a plurality of unit cells, each unit cell of the feed layer being formed of an antenna structure;
a metal layer disposed over the feed layer, the metal layer comprising a plurality of unit cells aligned with the plurality of unit cells of the feed layer; each unit cell of the metal layer having a pattern of metal segments; wherein a size and geometry of the metal segments controlling, at least in part, an impedance of the metal layer; and
a spacer layer disposed between the metal layer and the feed layer.

2. The TWA structure of claim 1, wherein the size and geometry of the metal segments of each unit cell of each metal layer controls an impedance associated with the metal layer; wherein increasing the size of the metal segments of each unit cell causes a decrease in impedance; and
wherein a decreasing size of the metal segments of each unit cell causes an increase in impedance.

3. The TWA structure of claim 1, wherein a gap between metal segments of adjacent unit cells controls an impedance associated with the metal layer; wherein increasing the gap between metal segments of adjacent unit cells causes an increase in impedance; and wherein a decreasing the gap between metal segments of adjacent unit cells causes a decrease in impedance.

4. The TWA structure of claim 3, wherein a length of the gap is selected to be approximately one half or less of a wavelength of a maximum frequency of the bandwidth ratio of the TWA.

5. The TWA structure of claim 1, wherein a thickness of the spacer layer controls an impedance value of the metal layer; wherein increasing the thickness of the spacer layer causes a decrease in impedance of the metal layer; and wherein decreasing the thickness of the spacer layer causes an increase in impedance of the metal layer.

6. The TWA structure of claim 1, wherein a width of metal segments of adjacent unit cells controls an impedance associated with the metal layer; wherein increasing the width of metal segments of adjacent unit cells causes a decrease in impedance; and wherein a decreasing the width of metal segments of adjacent unit cells causes an increase in impedance.

7. The TWA structure of claim 1, wherein the spacer layer is selected from foam or plastic.

8. The TWA structure of claim 1, wherein the antenna structures of the feed layer include at least one of a tapered antenna, a connected dipole antenna, and a connected slot antenna.

9. A travelling wave antenna (TWA) structure, comprising:
a feed layer comprising a plurality of unit cells, each unit cell being formed of an antenna structure;
a plurality of stacked metal layers disposed over the feed layer, each of the plurality of stacked metal layers comprising unit cells aligned with the unit cells of the feed layer and aligned with unit cells of adjacent metal layers; each unit cell of each metal layer having a pattern of metal segments; wherein a size and geometry of the metal segments of each unit cell of each metal layer controlling, at least in part, an impedance of the unit cell and the metal layer; and
a plurality of spacer layers disposed between a bottom metal layer and the feed layer and disposed between each metal layer.

10. The TWA structure of claim 9, wherein the size and geometry of the metal segments of each unit cell of each metal layer controls an impedance associated with the metal layer; wherein increasing the size of the metal segments of each unit cell causes a decrease in impedance; and wherein a decreasing size of the metal segments of each unit cell causes an increase in impedance.

11. The TWA structure of claim 9, wherein a gap between metal segments of adjacent unit cells controls an impedance associated with the metal layer; wherein increasing the gap between metal segments of adjacent unit cells causes an increase in impedance; and wherein a decreasing the gap between metal segments of adjacent unit cells causes a decrease in impedance.

12. The TWA structure of claim 11, wherein a length of the gap is selected to be approximately one half or less of a wavelength of a maximum frequency of the bandwidth ratio of the TWA.

13. The TWA structure of claim 9, wherein a thickness of each spacer layer controls an impedance value of adjacent metal layers; wherein increasing the thickness of the spacer layer causes a decrease in impedance of the metal layer; and wherein decreasing the thickness of the spacer layer causes an increase in impedance of the metal layer.

14. The TWA structure of claim 9, wherein a width of metal segments of adjacent unit cells controls an impedance associated with each metal layer; wherein increasing the width of metal segments of adjacent unit cells causes a decrease in impedance; and wherein a decreasing the width of metal segments of adjacent unit cells causes an increase in impedance.

15. The TWA structure of claim 9, wherein each of the plurality of spacer layers is selected from foam or plastic.

16. The TWA structure of claim 9, wherein the antenna structures of the feed layer include at least one of a tapered antenna, a connected dipole antenna, and a connected slot antenna.

17. The TWA structure of claim 9, wherein the plurality of transmission layers includes a top layer and the bottom layer; wherein a spacing between the bottom layer and the feed layer is less than a spacing between the bottom layer and the top layer.

18. The TWA structure of claim 17, wherein the plurality of spacer layers includes a first spacer layer disposed between the feed layer and the bottom layer, and a second spacer layer disposed between the bottom layer and the top layer; wherein the second spacer layer having a greater thickness than the first spacer layer.

19. The TWA structure of claim 9, wherein the plurality of metal layers are non-linearly spaced apart from one another to provide an approximate impedance match between the feed layer and free space.

20. The TWA structure of claim 9. wherein an overall length and width of the plurality of stacked metal layers is based on an overall power requirement of the TWA.
